(19) United States
(12) Patent Application Publication
(10) Pub. No.: US 2011/0308867 A1
(43) Pub. Date: Dec. 22, 2011

(54) HANDWRITING INPUT DEVICE WITH ELECTROMAGNETIC POWER TRANSMITTING

(75) Inventors: CHIA-JUI YEH, Taipei (TW); CHUNG-FUU MAO, Hsin-Chu (TW)

(73) Assignee: WALTOP INTERNATIONAL CORPORATION, HSIN-CHU CITY (TW)

(21) Appl. No.: 12/901,056

(22) Filed: Oct. 8, 2010

(30) Foreign Application Priority Data
Jun. 21, 2010 (TW) 099120117

(51) Int. Cl. G06F 3/033

(52) U.S. Cl. 178/19.01

(57) ABSTRACT

A handwriting input device with electromagnetic power transmitting is disclosed herein and includes a micro-controller, a power transferring coil, an electromagnetic pen and a filter. The micro-controller is configured to control for the first signal producing and the power transferring coil is configured to transfer the electromagnetic power of the first signal. The electromagnetic pen is configured to receive the electromagnetic power of the first signal and transform the electromagnetic power to be the second signal to transmit. The antenna loops are configured to receive the second signal and the filter is configured to filter the noise of the second signal.

### BACKGROUND OF THE INVENTION

1. Field of the Invention

The present invention is related to a handwriting apparatus, and more particularly related to an electromagnetic handwriting apparatus.

2. Description of the Prior Art

Most of the sensing theory of the handwriting apparatus (such as Tablet, Digitizer, Digital Whiteboard and so on) in market is Surface Acoustic Wave method, Electromagnetic method or Resistance method. Generally speaking, the Electromagnetic method is implemented by a double side sensing PCB board with X-axis and Y-axis antenna loops and an electromagnetic pen.

The electromagnetic pen using on the current electromagnetic handwriting apparatus can be divided into the handwriting apparatus with the battery electromagnetic pen and the handwriting apparatus with the battery-free electromagnetic pen. The battery electromagnetic pen is also called the active-type pen and this kind of the electromagnetic pen is not required the electromagnetic handwriting apparatus to transmit the electromagnetic energy to pen. The electromagnetic handwriting apparatus is only required to receive the electromagnetic signal from the electromagnetic pen. However, the drawback of the battery electromagnetic pen is the battery has to be replaced and the weight of the electromagnetic pen is a little heavy.

In addition, the battery-free electromagnetic pen is also called passive-type pen, such as the electromagnetic pen made by Wacom company and the detail specification is available in U.S. Pat. Nos. 4,878,553, 4,848,496 and 5,600,105. Because there is no battery inside the electromagnetic pen, the energy has to be transmitted from the handwriting apparatus to battery-free pen. Therefore, the antenna loop of the handwriting apparatus is required not only to receive the electromagnetic signal but also to transmit the electromagnetic energy to the its pen. When the handwriting apparatus is configured to detect the battery-free electromagnetic pen, the antenna loop is required to transmit the electromagnetic wave for couple time periods and then stop the electromagnetic wave transmitting and switch to the receiving mode. At the mean time, because the electromagnetic energy transmitted to the battery-free electromagnetic pen will soon dissipated quickly (the battery-free magnetic pen is not able to steadily transmit the electromagnetic power to the antenna loop), the antenna loop has to switch to the transmitting mode and the circuit is shown in FIG. 1A. According to the description above, the antenna loop wastes about half of period time to transmit the electromagnetic energy and only half period of time to receive the pen's electromagnetic signal. The drawback of the battery-free electromagnetic handwriting apparatus is the data quantity per second is lower than the previous one.

Moreover, there is another electromagnetic handwriting apparatus manufactured by Calcomp Company (U.S. Pat. No. 5,045,645) shown in FIG. 1B. The electromagnetic handwriting apparatus includes an Amplitude (AM) Carrier Wave Modulation (Mod) and a Sync Demodulation (Sync Memod) in the circuit board and transmits the modulated electromagnetic wave to the electromagnetic pen. Therefore, the envelop circuit of the electromagnetic pen will receive the envelop wave in its oscillator circuit and transmits the electromagnetic wave to handwriting apparatus with a lower frequency. The drawback of this handwriting apparatus is the frequency of the transmitting signal is unstable and is easy to be interrupted by the external electromagnetic field.

Therefore, according to the description above, it is necessary to design a new handwriting apparatus, which is able to overcome the drawbacks of the conventional handwriting apparatus and the electromagnetic pen is also configured without battery.

### SUMMARY OF THE INVENTION

The object of the present invention is to provide a novel handwriting apparatus to continue transmitting the electromagnetic power to the battery free electromagnetic pen.

Another object of the present invention is to modify the complicated steps of the handwriting apparatus switching between energy-transmitting mode and signal-receiving mode.

According to the objects above, a handwriting input device with electromagnetic power transmitting is disclosed herein and includes a micro-controller, a power transferring coil, an electromagnetic pen, antenna loops and a filter. The micro-controller is configured to control for the first signal producing and the power transferring coil is configured to transfer the electromagnetic power of the first signal. The electromagnetic pen is configured to receive the electromagnetic power of the first signal and transform the electromagnetic power to be the second signal to transmit. The antenna loops are configured to receive the second signal and the filter is configured to filter the noise of the second signal.

According to the objects above, a handwriting input device with electromagnetic power transmitting is disclosed herein and includes a micro-controller, a power transferring coil, an electromagnetic pen, antenna loops, a filter, a sampling circuit and a counter. The micro-controller includes a first clock and a second clock and the first clock and an oscillator are configured to generate the first signal. The power transferring coil is configured to transfer the electromagnetic power of the first signal. The electromagnetic pen is configured to receive the electromagnetic power of the first signal and transform the electromagnetic power to be the second signal to transmit. The antenna loops are configured to receive the second signal and the filter is configured to filter the noise of the second signal. The sampling circuit is configured to sample the filtered second signal with sine wave and the counter and the clock are used to calculate the frequency of the second signal.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic block diagram illustrating a conventional handwriting apparatus;

FIG. 1B is another schematic block diagram illustrating a conventional handwriting apparatus;

FIG. 2A is a schematic block diagram illustrating an electromagnetic handwriting apparatus in the present invention;

FIG. 2B is an AC waveform of the first signal;

FIG. 2C is an AC waveform of the combination of the first signal and the second signal; and

FIG. 2D is a sine waveform diagram of the second signal.

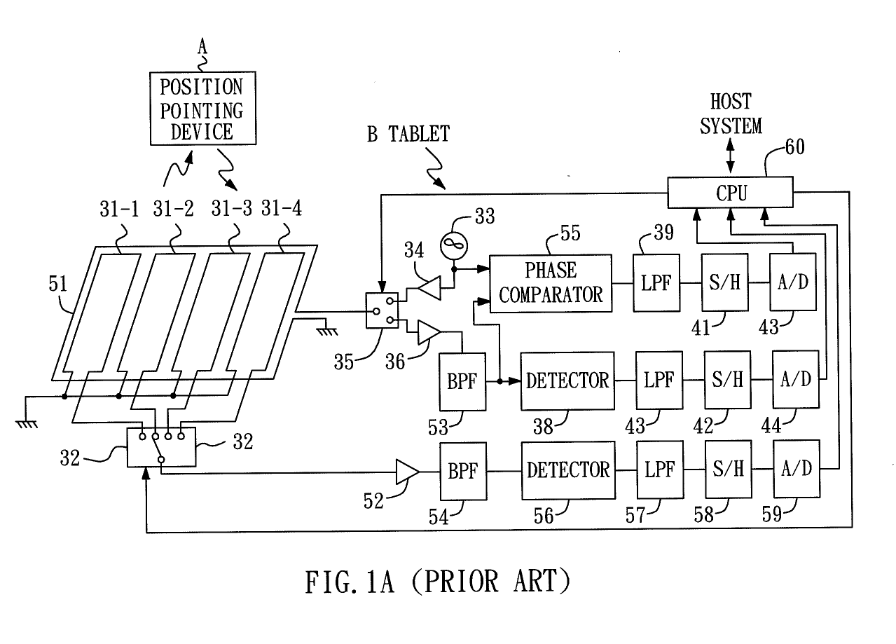

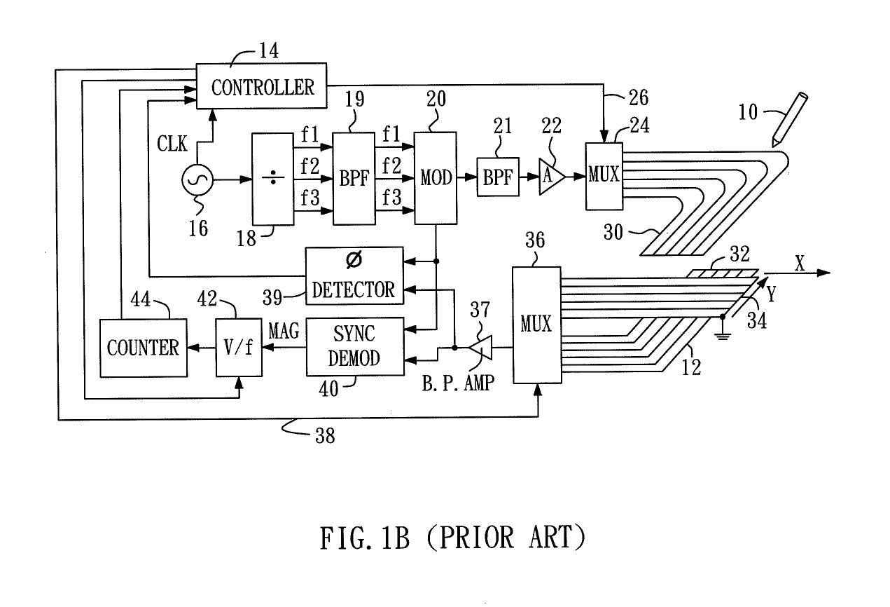

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

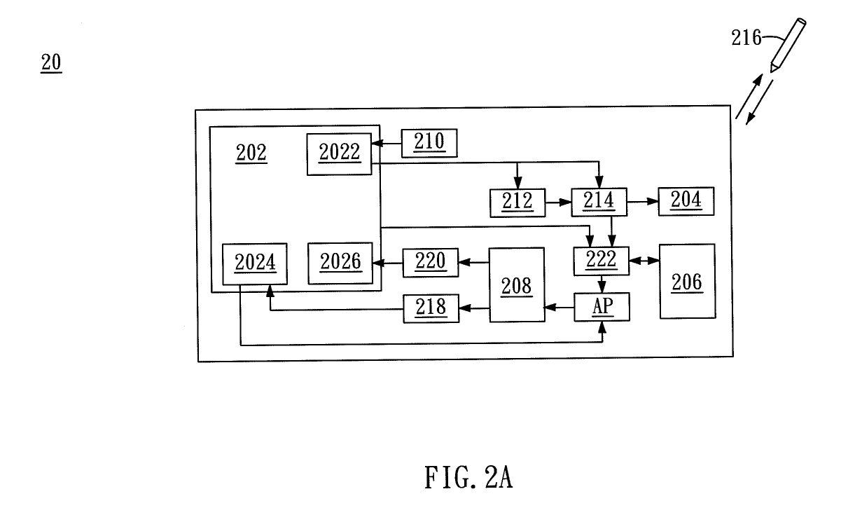

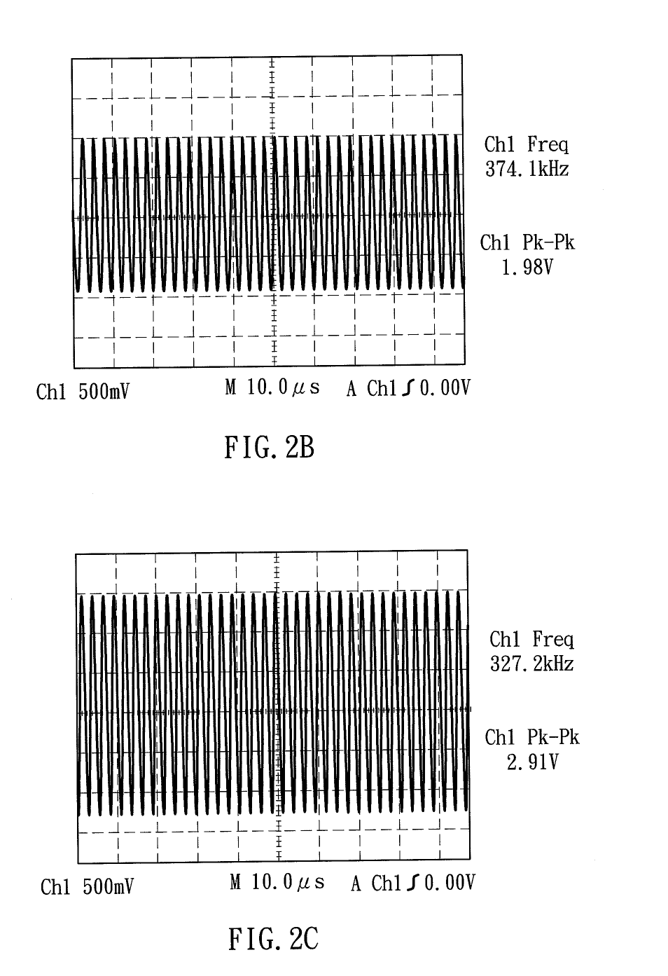

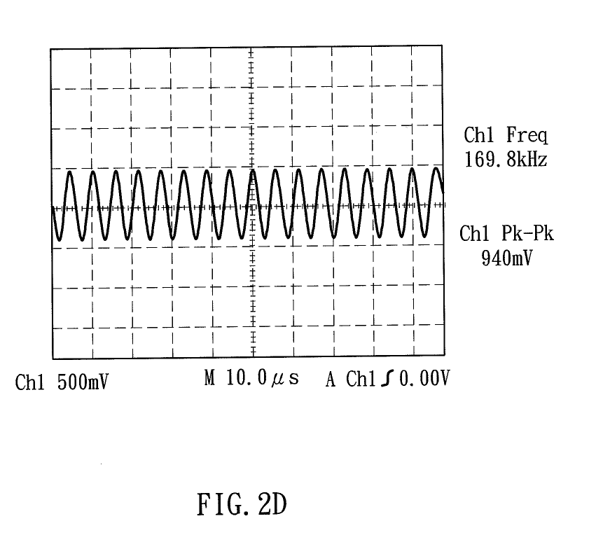

FIG. 2A is a sketch diagram illustrating that an electromagnetic handwriting apparatus in the present invention. As shown in FIG. 2A, the electromagnetic handwriting apparatus 20 includes a micro-controller 202, a power transferring coil 204, an antenna loop 206 and a filter 208. The micro-controller is configured to generate a first clock 2022 and a second clock 2024 and the first clock 2022 is cooperated with an oscillator 210 to provide a continuous square wave signal (also called a first signal) with a specific frequency to the electromagnetic handwriting apparatus 20. The continuous square wave signal with the specific frequency will be transmitted to an inverter 212 and an AC driver circuit 214. The square wave signal will be transform to be AC signal with the same frequency by the inverter 212 and the AC driver circuit 214. The signal diagram illustrating the AC signal transformed form the square wave signal by the inverter 212 and the AC driver circuit 214 is in FIG. 2B. Thereafter, the continuous AC signal is transmitted to the power transmitting coil 204 and the power of the signal is continually transmitted by the power transmitting coil 204 to the electromagnetic pen 216 in a electromagnetic wave format.

Subsequently, still referring to FIG. 2A, the electromagnetic pen 216 continually receives the electromagnetic power of the first signal and then continually transmitted a second signal with a frequency different to the frequency of the first signal. The antenna loop 206 of the electromagnetic handwriting apparatus 20 is configured to continually receive the second signal. However, the antenna loop 206 of the electromagnetic handwriting apparatus 20 may receive not only the second signal but also the first signal and other noises, as shown in FIG. 2C. Therefore, a filter 208 is configured to filter the unnecessary signal (such as the first signal) out. It should be noted that the filter 208 in the present embodiment is a band pass filter and the filter 208 in a different embodiment of the present invention can be a high pass filter to filter the signal with lower frequency if the frequency of the first signal is lower than the frequency of the second signal. Likewise, the filter 208 in the present invention can be a low pass filter to filter the signal with higher frequency and it is not limited herein. Therefore, the stable second signal with sine wave is received after filtering by the filter 208, as shown in FIG. 2D, and the sine wave is transmitted to the micro-controller 202. Eventually, the micro-controller 202 will calculate the coordinate of the electromagnetic pen 216 in X-axis and Y-axis in accordance with the sine wave.

It should be noted that the handwriting apparatus in the present invention further includes a sampling circuit 218, and the sampling circuit 218 is configured to sample the filtered second signal with sine wave and the second signal is then doing the analog/digital (A/D) signal convert by an A/D converter 2024 in the micro-controller 202. Moreover, a counter 220 and the second clock 2026 of the micro-controller 202 is used to calculate the frequency of the second signal with sine wave. Eventually, the micro-controller 202 will calculate the coordinate of the electromagnetic pen 216 in X-axis and Y-axis in accordance with the digital signal converted from the second signal and the frequency of the sine wave. In addition; the handwriting apparatus 20 in the present invention further includes a multiplexer 224 and the micro-controller 202 controls the multiplexer 222 to choose the signal from the drive circuit 214 or the antenna loop 206 to be the input signal and then transmit it to the filter 208.

As the description above, according to the circuit design of the handwriting apparatus 20 in the present invention, the handwriting apparatus 20 is able to continually transmit power to the electromagnetic pen 216 rather than the conventional handwriting apparatus is needed to switch the transmitting mode and the receiving mode. The electromagnetic pen 216 is also not required to install battery therein to keep transmitting the signal for the handwriting apparatus 20 to detect. On the other hand, in the circuit design, there is no Phase Comparator, Modulation (MOD) or Sync Demodulation (Sync Mod) installed therein to switch signal transmitting and signal receiving. In conclusion, the handwriting apparatus 20 in the present invention improves the drawback of the overweight of the conventional electromagnetic pen with battery and the problem of the half data rate of conventional battery-free pen without increasing the extra cost of the circuit design.

Although specific embodiments have been illustrated and described, it will be appreciated by those skilled in the art that various modifications may be made without departing from the scope of the present invention, which is intended to be limited solely by the appended claims.

What is claimed is:

1. A handwriting apparatus with electromagnetic power transmitting, comprising:
a micro-controller configured to continually generate a plurality of first signals;
a power transferring coil configured to continually transfer the plurality of first signals in an electromagnetic wave format;
an electromagnetic pen configured to continually receive the electromagnetic power of the first signals and transform the electromagnetic power of the first signals to be a plurality of second signals to transmit;
an antenna loops configured to continually receive the plurality of second signals; and
a filter configured to continually filter the noise of the plurality of the second signals;
wherein the frequency of the first signal is different to the frequency of the second signal, and the plurality of the first signals is generated by a first clock and an oscillator.

2. The handwriting apparatus of claim 1 further comprising an inverter and an AC driver circuit, and the first signals are continually transformed to be AC signals by the inverter and the AC driver circuit.

3. The handwriting apparatus of claim 1 further comprising a sampling circuit, which is configured to sample the sine wave of the filtered second signal.

4. The handwriting apparatus of claim 3 further comprising a counter, and the frequency of the second signal is calculated by the counter and a second clock of the micro-controller.

5. The handwriting apparatus of claim 1, wherein the handwriting apparatus is an electromagnetic handwriting apparatus.

6. A handwriting apparatus with electromagnetic power transmitting, comprising:
a micro-controller includes a first clock and a second clock and the first clock and an oscillator are configured to generate a plurality of first signals;
a power transferring coil configured to continually transfer the plurality of first signals in an electromagnetic wave format;
an electromagnetic pen configured to continually receive the electromagnetic power of the first signals and transform the electromagnetic power of the first signals to be a plurality of second signals to transmit;
an antenna loops configured to continually receive the plurality of second signals;
a filter configured to filter the noise of the plurality of the second signals;
a sampling circuit configured to sample the sine wave of the filtered second signal; and
a counter, and the frequency of the second signal is calculated by the counter and a second clock of the micro-controller;
wherein the frequency of the first signal is different to the frequency of the second signal.

7. The handwriting apparatus of claim 6 further comprising an inverter and an AC driver circuit, and the first signal is transformed to be AC signal by the inverter and the AC driver circuit.

8. The handwriting apparatus of claim 6, wherein the handwriting apparatus is an electromagnetic handwriting apparatus.
